(19) United States
(12) Patent Application Publication
(10) Pub. No.: US 2015/0073923 A1
(43) Pub. Date: Mar. 12, 2015

(54) SYSTEM AND METHOD FOR PROVIDING INTERACTIVE EBOOK CONTENT ANNOTATIONS AND ADVERTISEMENTS

(71) Applicant: Usman Hafeez, Chicago, IL (US)

(72) Inventor: Usman Hafeez, Chicago, IL (US)

(21) Appl. No.: 14/023,913

(22) Filed: Sep. 11, 2013

(51) Int. Cl. G06Q 30/02; G06F 17/24

(52) U.S. Cl. CPC G06Q 30/0277; G06F 17/241
USPC 705/14.73

(57) ABSTRACT

The present invention generally relates to computer and web-based systems and methods for adapting eBooks and other digital content. Specifically, this invention relates to systems and methods for providing interactive content annotations and advertisements by allowing for point based placement of annotations and dynamic matching of proximity content between various eBooks or other forms of digital content. Further, embodiments of the present invention provide systems and methods to allow for the adaptation of the content or format of a eBook or other form of digital content in response to placement of an annotation. In addition, embodiments of the present invention provide systems and methods to provide eBooks or other digital content at a set price with the addition of annotations and advertisements, as well as provide for the sale or credit from the addition of annotations and advertisements.

### FIELD OF THE INVENTION

The present invention generally relates to computer and web-based systems and methods for adapting eBooks and other digital content. Specifically, this invention relates to systems and methods for providing interactive content annotations and advertisements by allowing for point based placement of annotations and dynamic matching of proximity content between various eBooks or other forms of digital content. Further, embodiments of the present invention provide systems and methods to allow for the adaptation of the content or format of an eBook or other form of digital content in response to placement of an annotation. In addition, embodiments of the present invention provide systems and methods to provide eBooks or other digital content at a set price with the addition of annotations and advertisements, as well as provide for the sale or credit from the addition of annotations and advertisements.

### BACKGROUND

The use of digital books, or eBooks, has grown and is expected to surpass purchases of printed books in the near future. One market where this will be especially prevalent is in school textbooks. In connection with this, there have been strides made to add functionality to eBooks such that they mimic printed books. In addition, there have been strides made to add functionality in eBooks that are not possible in printed books.

With the industry shift over to ePub and other forms of “free flowing” text for the publication of eBooks, there is presented opportunities and obstacles for the addition of digital content within the eBook. The shift to ePub is to have text that “fits” within the dimensions of a given mobile device or browser such that the user can have multiple size devices and have control of the size of the font, with the text automatically fitting within the given space. Current implementations of adding annotations to selected text have several shortcomings.

For instance, there is no method to allow for the easy association of annotations to both “flowing text” as well as fixed text documents where the selected text is in the same location in a given page, such as by having a fixed page PDF. Further, annotations associated with flowing or fixed text may be allowed, but there is no ability to share annotations between users, devices or other formats of the same eBook or of another eBook that has the same text.

There is also no current method to add annotations without the selection of text.

Additionally, there are no formats, software or systems that allow for the addition of multimedia content in annotations or otherwise attach such multimedia content to selected text.

Also, users of eBooks are not provided any method or manner for searching and displaying of pertinent annotations added by other users based on selected text, proximity text or any other associated text. For example, there currently does not exist the ability for User A to find and display annotations that were added by User B to a different eBook but which can add value to User A's reading experience if those annotations can be displayed in the appropriate location in User A's eBook. A practical example of this is if User A has the eBook which consists of the story “A Scandal in Bohemia” by Sir Arthur Conan Doyle, and User B has the eBook “The Adventures of Sherlock Holmes” by Sir Arthur Conan Doyle, which contains the story “A Scandal in Bohemia” amongst its stories. If User B adds annotations (such as notes, videos, images, audio, etc.) to selected text in the story “A Scandal in Bohemia” for the eBook “The Adventures of Sherlock Holmes”, User A should be able to find User B's annotations and have those annotations appear in User A's copy of “A Scandal in Bohemia” based on the association of selected text committed by User B. However, currently these abilities are not available.

Finally, there is no market place for the increase or decrease in the price of an eBook with the addition of annotations and advertisements. There is also no market place for the sale or credit of annotations and advertisements separate from an eBook.

Therefore, there is need in the art for a computer and web-based systems and methods for providing interactive content annotations and advertisements by allowing for point based placement of annotations and dynamic matching of proximity content between various eBooks or other forms of digital content. These and other features and advantages of the present invention will be explained and will become obvious to one skilled in the art through the summary of the invention that follows.

### SUMMARY OF THE INVENTION

Accordingly, it is an aspect of the present invention to provide a system and method for providing interactive content annotations and advertisements by allowing for point based placement or association of annotations and dynamic matching of proximity content between various eBooks or other forms of digital content.

According to an embodiment of the present invention, a system for providing interactive eBook content annotations and advertisements includes: an annotation module, comprising computer-executable code stored in non-volatile memory, an advertising module comprising computer-executable code stored in non-volatile memory, a processor, and a communications means, wherein said advertising module, said annotation module, said processor, and said communications means are operably connected and are configured to: receive an annotation request from a first user; identify an annotation location based on said annotation request; identify an annotation content based on said annotation request; generate a identified location based annotation based at least in part on said annotation content and said annotation location; and store said identified location based annotation in association with an eBook or other digital content format.

According to an embodiment of the present invention, said annotation content is selected from the group comprising video, audio, images, text, hyperlinks, multimedia content and advertisements.

According to an embodiment of the present invention, said identified location based annotation is made available to one or more secondary users.

According to an embodiment of the present invention, one or more secondary users may be linked to said first user via a social network connection.

According to an embodiment of the present invention, one or more secondary users are linked to said first user via a public connection.

According to an embodiment of the present invention, identified location based annotation is provided to one or more of said one or more secondary users as a result of a search conducted by said one or more secondary users.

According to an embodiment of the present invention, the search conducted by said one or more secondary users identified said identified location based annotation based at least in part on matching a subset of text in proximity to said annotation location and a second text identified by said one or more of said one or more secondary users present in a second eBook.

According to an embodiment of the present invention, said advertising module, said annotation module, said processor, and said communications means are further configured to amend a price of said eBook or other digital content format, wherein said price of said eBook or other digital content format is a lower or higher price than a standard price for said eBook or other digital content format.

According to an embodiment of the present invention, the advertising module, said annotation module, said processor, and said communications means are further configured to provide said eBook or other digital content format to a second user at said price.

According to an embodiment of the present invention, the advertising module, said annotation module, said processor, and said communications means are further configured to provide said annotations or advertisements in digital content format to a user at said price or credit.

According to an embodiment of the present invention, a computer implemented method for providing interactive eBook content annotations and advertisements includes the steps of: receiving an annotation request from a first user; identifying an annotation location based on said annotation request; identifying an annotation content based on said annotation request; generating an identified location based annotation based at least in part on said annotation content and said annotation location; and storing said identified location based annotation in association with an eBook or other digital content format.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3 illustrates a network schematic of a system, in accordance with an embodiment of the present invention;

FIG. 4A illustrates a schematic of a system for providing interactive eBook content annotations and advertisements, in accordance with an embodiment of the present invention;

FIG. 4B illustrates a schematic of a system for providing interactive eBook content advertisements, in accordance with an embodiment of the present invention;

FIG. 4C illustrates a schematic of a system for providing interactive eBook content annotations, in accordance with an embodiment of the present invention;

FIG. 5 illustrates a schematic of a system for providing interactive eBook content annotations and advertisements, in accordance with an embodiment of the present invention; and

FIG. 6 is a process flow of an exemplary method in accordance with embodiments of the present invention; and

FIG. 7 is a process flow of an exemplary method in accordance with embodiments of the present invention.

### DETAILED SPECIFICATION

The present invention generally relates to computer and web-based systems and methods for adapting eBooks and other digital content. Specifically, this invention relates to systems and methods for providing interactive content annotations and advertisements by allowing for point based placement of annotations and dynamic matching of proximity content between various eBooks or other forms of digital content. Further, embodiments of the present invention provide systems and methods to allow for the adaptation of the content or format of an eBook or other form of digital content in response to placement of an annotation. In addition, embodiments of the present invention provide systems and methods to provide eBooks or other digital content at a set price with the addition of annotations and advertisements, as well as provide for the sale or credit from the addition of annotations and advertisements.

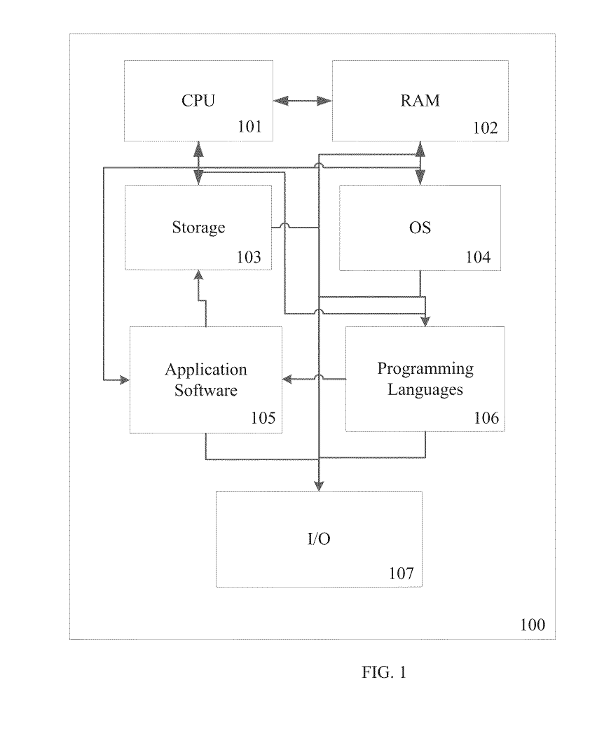

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) 103, an operating system (OS) 104, one or more application software 105, one or more programming languages 106 and one or more input/output devices/means 107. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

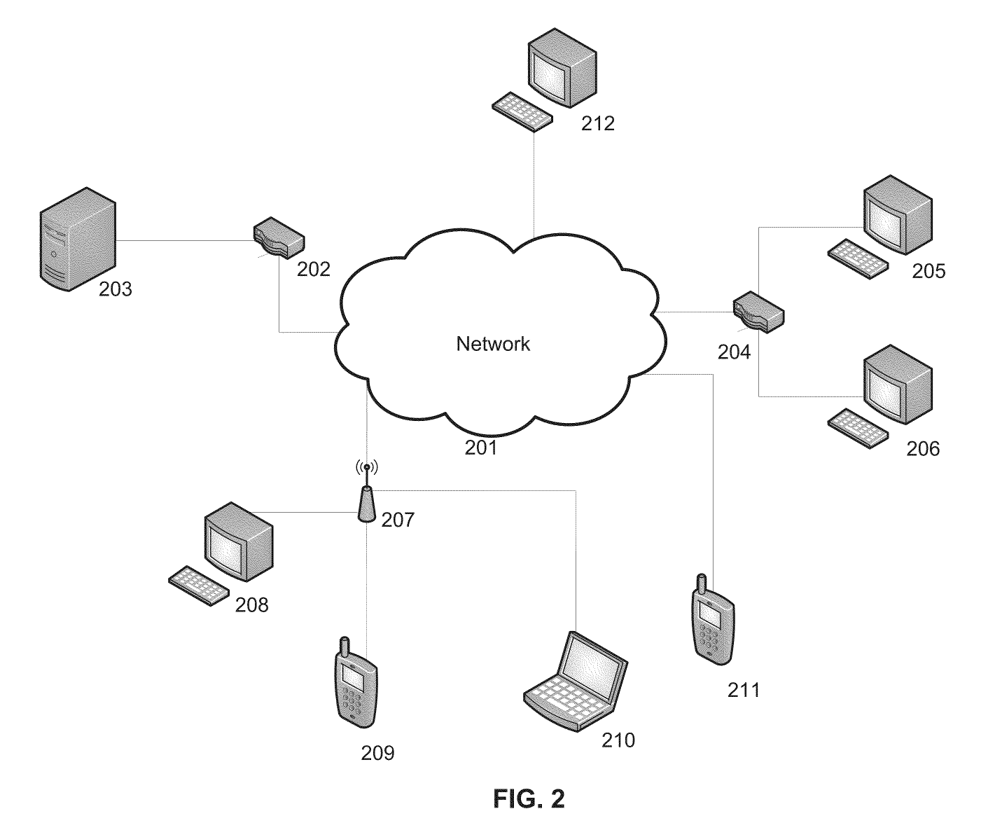

Referring to FIG. 2, a schematic overview of a system in accordance with an embodiment of the present invention is shown. The system is comprised of one or more application servers 203 for electronically storing information used by the system. Applications in the application server 203 may retrieve and manipulate information in storage devices and exchange information through a Network 201 (e.g., the Internet, a LAN, WiFi, Bluetooth, etc.). Applications in server 203 may also be used to manipulate information stored remotely and process and analyze data stored remotely across a Network 201 (e.g., the Internet, a LAN, WiFi, Bluetooth, etc.).

According to an exemplary embodiment, as shown in FIG. 2, exchange of information through the Network 201 may occur through one or more high speed connections. In some cases, high speed connections may be over-the-air (OTA), passed through networked systems, directly connected to one or more Networks 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to Network 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via Network 201 or other network in numerous ways. For instance, a component may connect to the system i) through a computing device 212 directly connected to the Network 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the Network 201. One of ordinary skill in the art would appreciate that there are numerous ways that a component may connect to server 203 via Network 201, and embodiments of the present invention are contemplated for use with any method for connecting to server 203 via Network 201. Furthermore, server 203 could be comprised of a personal computing device, such as a smartphone, acting as a host for other computing devices to connect to.

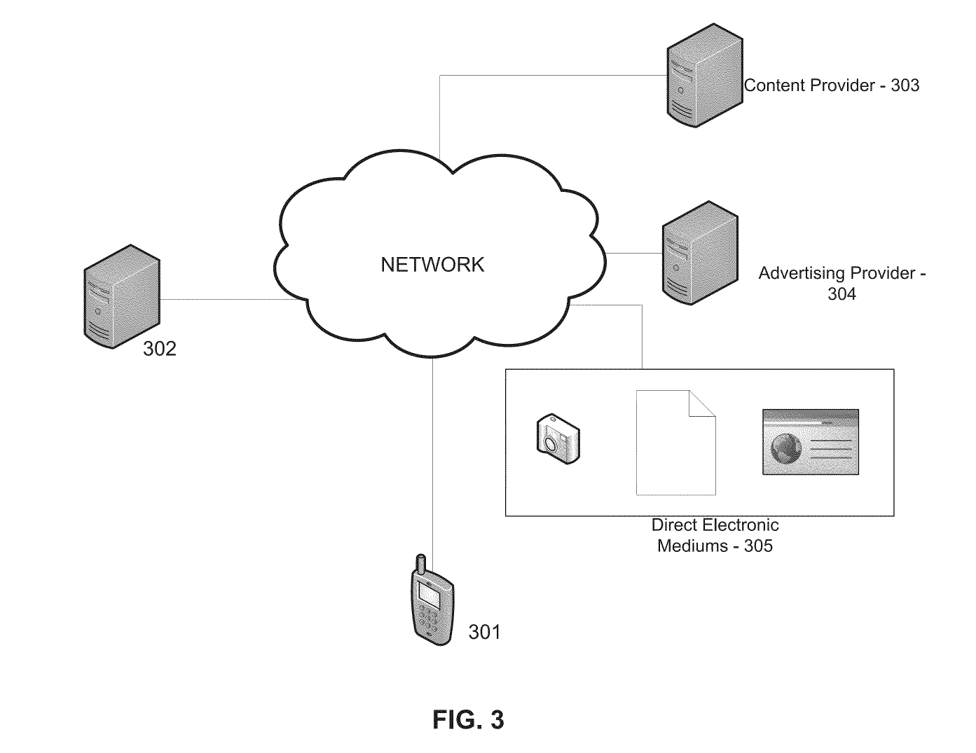

Turning now to FIG. 3, a continued schematic overview of a system in accordance with an embodiment of the present invention is shown. In FIG. 3, the system is shown as it may interact with users and other third party networks or APIs. For instance, a user of a mobile device 301 may be able to connect to application server 302. Application server 302 may be able to enhance or otherwise provide additional services to the user by requesting and receiving information from one or more of a content provider 303, an advertising provider API/website or other third party advertising system 304, one or more direct links or other directly provided data in the form of an electronic medium 305 (e.g., product photo, product brochure, service description, uniform resource locator (URL)) or any combination thereof. One of ordinary skill in the art would appreciate how accessing one or more third-party systems could augment the ability of the system described herein, and embodiments of the present invention are contemplated for use with any third-party system.

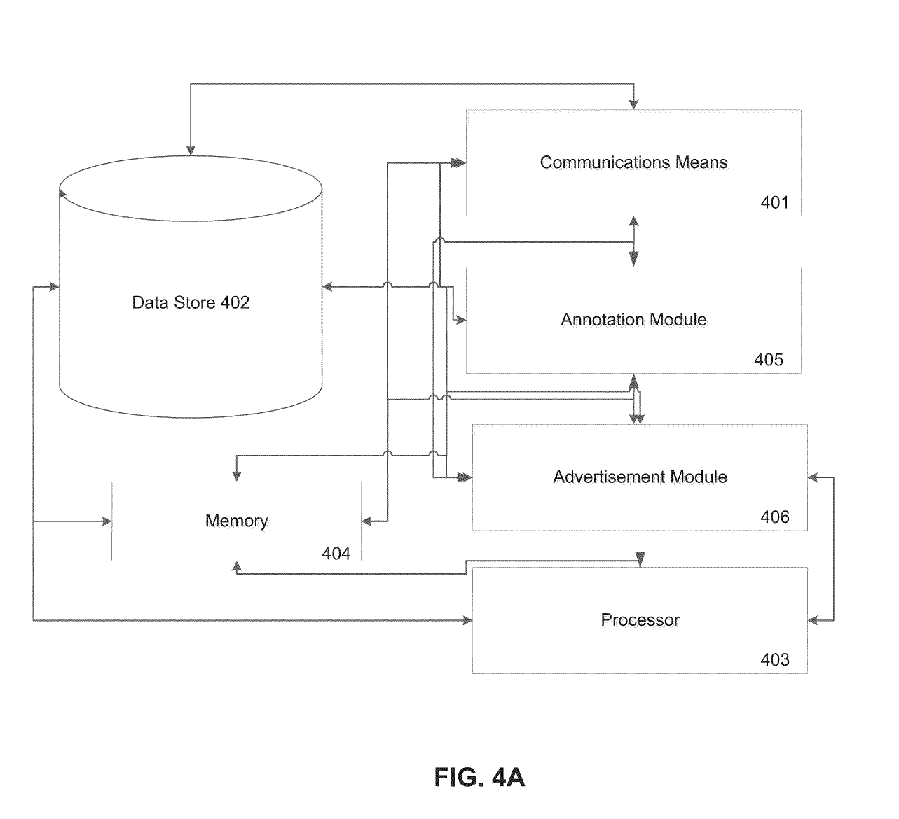

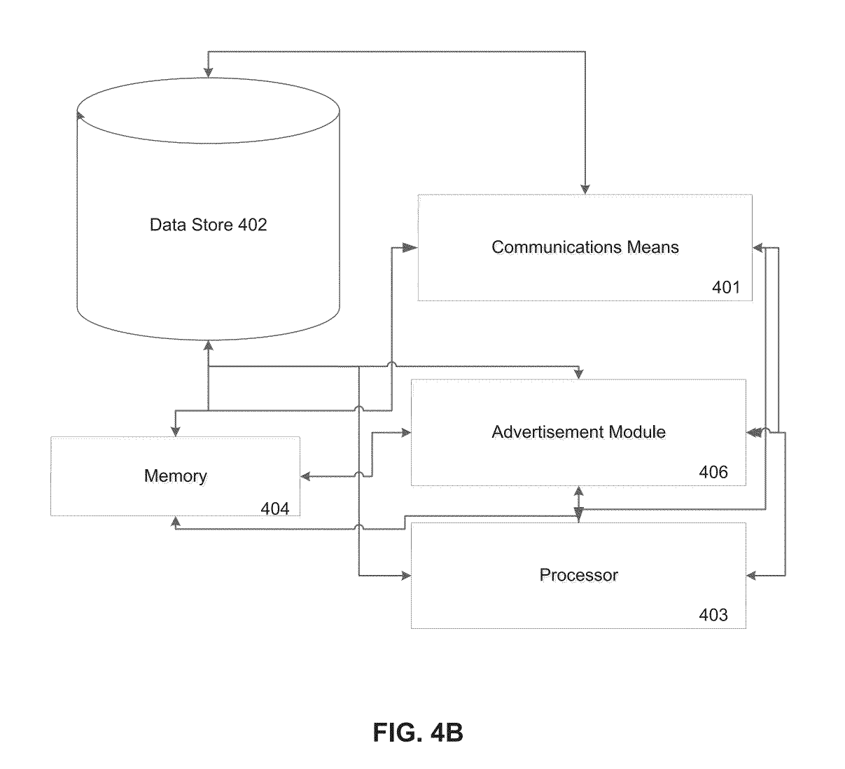

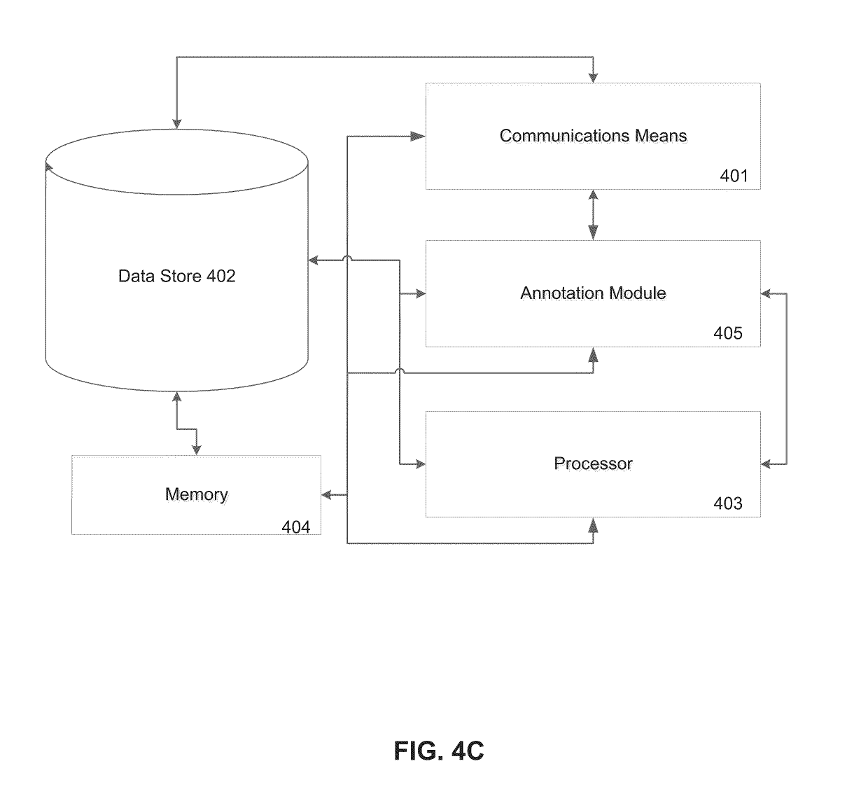

Turning to FIG. 4A, according to an embodiment of the present invention, a system for providing interactive eBook content annotations and advertisements is comprised of one or more communications means 401, one or more data stores 402, a processor 403, memory 404, an annotation module 405 and an advertisement module 406. In FIG. 4B, according to an embodiment of the present invention, a system for providing interactive eBook content advertisements is comprised of one or more communications means 401, one or more data stores 402, a processor 403, memory 404 and an advertisement module 406. In FIG. 4C, according to an embodiment of the present invention, a system for providing interactive eBook content annotations is comprised of one or more communications means 401, one or more data stores 402, a processor 403, memory 404 and an annotation module 405. In alternate embodiments, the system may have additional or fewer components. One of ordinary skill in the art would appreciate that the system may be operable with a number of optional components, and embodiments of the present invention are contemplated for use with any such optional component.

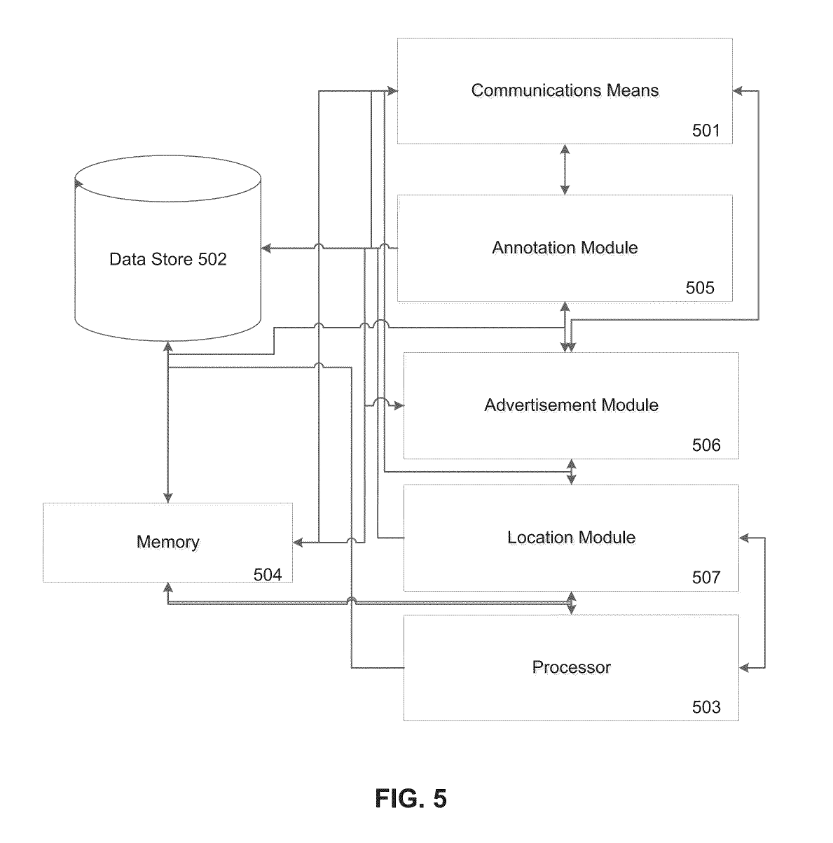

FIG. 5, shows an alternate embodiment of a system for providing interactive eBook content annotations and advertisements, comprised of one or more communications means 501, one or more data stores 502, a processor 503, memory 504, an annotation module 505 an advertisement module 506 and further including a location module 507. In alternate embodiments, the system may have additional or fewer components. One of ordinary skill in the art would appreciate that the system may be operable with a number of optional components, and embodiments of the present invention are contemplated for use with any such optional component.

According to an embodiment of the present invention, the communications means of the system may be, for instance, any means for communicating data, voice or video communications over one or more networks. Appropriate communications means may include, but are not limited to, wireless connections, wired connections, cellular connections, data port connections, Bluetooth connections, fiber optic connections, modems, network interface cards or any combination thereof. One of ordinary skill in the art would appreciate that there are numerous communications means that may be utilized with embodiments of the present invention, and embodiments of the present invention are contemplated for use with any communications means.

According to an embodiment of the present invention, the location module is configured to provide location based services (LBS) to enhance user experience and functionality. The location module may be configured to utilize location based information provided from the user via one or more location means (e.g., Global position System (GPS), cellular triangulation, IP address location) to provide specific information and services to the user. This LBS information may be utilized by the various other components of the system to enhance content provided by those components (e.g., provide advertising/annotations based on user's current location).

According to an embodiment of the present invention, the annotation module is configured to allow users to select text and add annotations which can include multimedia annotations to eBooks or other forms of digital content. The annotation module may further be configured to allow a user to share the annotations with other users, such as via third-party social networks, expanded social networks, or by making their annotations public to anyone looking to view the said annotations within their eBook or other form of digital content.

Additionally, the annotation module is configured to allow a user to display annotations added by other users. These annotations may be provided to the user via the same methods noted above with respect to the sharing of annotations (e.g., via social networks, via public annotations). In certain embodiments, the annotation module may allow a user to search for and display annotations based one or more criteria associated with the eBook or other digital content, such content including, but not limited to: searching for annotations in an entire eBook; searching for annotations for pages being viewed; searching annotations for selected text; searching annotations that have some selected text as a subset of associated text; searching for annotations where the associated text is a subset of the selected text; or any combination thereof.

In addition, embodiments of the present invention may be configured to automatically find associated text with annotations and display to one or more users the number and location of annotations within the eBook or other form of digital content. For example, a user can upload an eBook, document, article, etc. and be immediately informed that there are ‘x’ number of annotations which can be displayed, and have those annotations displayed based on user selecting whose annotations they would like to see. A user with a new eTextbook can find that users have added annotations in a prior version of the textbook that can be displayed within the new version of the textbook. The system can work in reverse, where the system can find eBooks wherein the associated text lies. This can be applied to that sharing aspect to the current invention, where the user can share annotations with other users within their network, where knowing that a given user's annotations can be shared with another user who may not have the same book as the sharer.

According to an embodiment of the present invention, the annotation module may be configured to associate and link annotations not just with particular text, but also via particular locations within an eBook or other digital content. Location annotations may be inserted and associated in an eBook or other digital content on any number of points, including, but not limited to, a textual location identified by the user (e.g., end of sentence, end of paragraph, middle of sentence, start of a specific word, end of a specific word), a graphical location identified by the user (e.g., a specific pixel or set of pixels identified by the user) or any combination thereof. With regards to graphical locations, since page numbers and locations in eBooks and other forms of digital content may vary depending on screen size and resolution of a particular devices, the annotation module may be configured to record graphical locations in relation to other information points associated with the eBook or other form of digital content. For instance, if a graphical location is set for a particular eBook being read at an identifiable screen size, pixel resolution and font size (the “identified location”), the system may be configured to convert the graphical location for other users based on a comparison of the identified location with the same or similar properties of devices utilized by other users. So an identified location set by a first user may be at a different “page” number for a second user, but the annotation module can make the conversion and appropriately place the annotation for the second user based on the characteristics of the second user's computing device. It should be noted that an identified location may be a specific point or a region (e.g., area selected by user comprising more than one pixel or exact location, such as a geometric shape). In some embodiments, when the annotation is associated to text within a fixed-text file, such as a PDF, the location can be determined by a word offset from the beginning of the page or through the use of Cartesian Coordinates identifying the beginning and end of the selected text for a given eBook.

In certain embodiments, the annotation module allows users to associate and/or embed annotations within text of an eBook. The annotation may be embedded in the case of an ePub or similar “flowing text” type file, such that the annotation is displayed within the context of the text, or the annotation may be hidden or off to the side of the text in the case non-flowing text file, such as a PDF. The user can associate the annotation at any point within an eBook, be it at the end of a word, in the middle of a word, at the end of a paragraph, or anywhere else the user chooses to place or associate an annotation.

In some embodiments, regardless of a fixed-text or flowing-text type file, when the annotation is associated to a certain point within the eBook, the system can associate the annotation to selected point by storing the text before and after that point along with the annotation. The system can store a certain number of words or characters before or after that point in order to identify that point in other eBooks. In these embodiments, since the annotation is associated to a certain point within the eBook by the use of text before and after that point rather than to a particular eBook, these annotations can be applied to any eBook containing the same text before and after the selected point. For example, a user adding annotations to a given point can now have those annotations applying to any other document/eBook/etc. containing that text.

According to an embodiment of the present invention, said annotations are stored in association with the location with regards to the text in a server.

According to an embodiment of the present invention, identified locations need not be set on or in line with other text or graphical content of the eBook or other digital content format. This allows for identified locations to be in the margins, between the lines, above lines, in a header, in a footer or anywhere else within the contents of the eBook or other digital content format. One advantage of identified location annotations is that they are convenient for use with modern devices with capacitive touch screens or other touch enabled devices where selection of words or in line/on line text is difficult or less accurate.

With respect to searching and sharing annotations, annotations associated with an identified location may utilize similar searching and sharing techniques identified above, but modified to allow for the non-standard placement of the identified location. For instance, text based searching can be processed whereby the identified location is used as a basis point for textual searches. In this manner, the annotation module may be configured to search texts based on proximity to the identified location (e.g., N number of words before, N number of words after, search words above identified location, search words below identified location, search nearest words to identified location).

One advantage of such identified location placement of annotations is that the annotation can take advantage of the ability for text to ‘flow’ around the annotation such that when multimedia annotations are added, the annotations can be displayed and have the text align around the display element within the devise display. For instance, if a picture is added by user A, the picture will be displayed within the text at a given point, and this relative point (relative to the text around it) will be displayed regardless of devices screen size. When shared with user B, user B will see the multimedia annotation in the same relative location as that added by user A, even if there was no text selected and user B does not have the same eBook as user A. With this functionality of the invention, any plain eBook can become a multimedia eBook through shared content added by users.

One unique feature of the above lies in that there is no need to associate text to a particular eBook, thereby limiting the annotation to only users with that same eBook. Rather, the annotation is associated with a selected text, or to a certain point within the page relative to text preceding and after that point on the page. There can also be additional information saved to server, such as the author, title of the book, ISPN, etc. This information allows for quick searching, retrieval and display when a user uses limiting criteria for the search, such as where a user can find all annotations added by other users for a particular author, which will allow annotations associated to text within the user's eBook to appear, with the annotations appearing due to the eBook having the same text and same author for this example.

According to an embodiment of the present invention, the advertisement module works in a similar manner as the annotation module, except that the advertisement module allows for the inclusion of advertisements within eBooks. In certain embodiments, the advertisement module may be configured to incorporate advertisements interspersed within an eBook or other form of digital content such that a user is provided the content such that the content incorporates one or more advertisements directly within the content. EBooks or other forms of digital content may be provided in this manner by users selecting to loan/rent/buy such content at a discount or for receiving some other benefit (e.g., chance to win a prize, entrance into a contest, chance to be provided early access to new content or new books/series).

In certain embodiments, the system and method may allow the advertising to be interspersed without changing the page numbering within the eBook or other form of digital content so that a certain page referenced will be the same between users who have the same eBook or other form of digital content with or without advertising.

In addition, in certain embodiments users can select the number of ads they will encounter and length of time the advertisement is displayed within the eBook, which can than determine the price charged to the user. In this manner, the advertisement module may be configured to provide dynamic pricing for content based on the user's willingness to be exposed to advertisements.

According to an embodiment of the present invention, the advertising may be static, dynamic or any combination thereof. For static advertising content, the system may be configured to allow the eBook to be downloaded or otherwise consumed with the advertising directly included in the content. In dynamic advertisement content, the advertising can change based on the reading material, subject of the eBook, user demographics, eBook location, businesses within close proximity to eBook or the user's computing device (e.g., as identified via the location module). For instance, if a user is reading their eBook in a mall, there can be targeted advertisements interspersed within the eBook delivered based on the businesses/institutions in close proximity that choose to broadcast their advertisements/coupons to the user. In addition, if the user clicks through the ad or makes a purchase based on an advertisement, they can be awarded ‘points’ that can be used towards the purchase of future eBooks, or to have advertising removed in the eBook(s) the user is currently reading.

With respect to the identified location aspects of annotations, and, in the present example advertisements, the ramifications of embodiments of the present invention are very important. The identified location based advertisement allows for advertising to be embedded within an eBook with the advertisement in the same relative location regardless of the device display, which is also effected by the font size the user has chosen. An expansion on this concept is to allow advertisers to embed their advertisements, with one embodiment allowing for users to save money by allowing for the display of these advertisements within their purchased or rented eBook. Much like the user can pick whose annotations can be displayed within their eBook, the user can also pick which advertisements, such as from a particular company or type of advertisement (such as sports related) can be displayed to them within their eBook, which can result in a reduced cost at the time of purchasing or renting the eBook, or can be translated to a money/point equivalent which can be applied to future purchases/renting of digital items.

In certain embodiments, the system may provide a method whereby money/points are used towards forward purchases/rentals and can be tied such that earning of such points will only occur when a user clicks through, engages with and/or makes a purchase based on the advertisement, thereby giving the advertisers an incentive to place the advertisement within the digital content, as well as the user to explore an advertisement or make a purchase. In one embodiment, the clicking of the advertisement will not cause the user to lose their spot on the eBook, as when they exit out of the advertisement or make a purchase, the system returns the user to the point from whence they clicked the advertisement.

According to an embodiment of the present invention, there is presented a system and method of having a market place for the selling of eBooks and their associated annotations. There is provided the means for the user adding annotations to charge for the annotations being added, thereby making a market place for annotations for digital content. An example would be of a publisher that either sells an eBook for very little to nothing, but then invites viewers/purchasers/renters of the eBook to view the additional annotations, but for an additional price. This way, there is more channels for a publisher to make money on an eBook, where a text only eBook can sell for a certain price, while one with annotations (illustrations, videos, audio, etc.) can sell at a different price. This can be expanded such that it is not only publishers, but anyone can add valuable annotations within an eBook, and have a market to sell that additional digital content to an eBook. Likewise, for an advertiser, the marketplace will allow for the selling of eBooks at a discount when they contain the advertiser's advertisements in the form of annotations. For example, an advertiser may choose to sell an eBook at a discount if that eBook contains the advertiser's annotations, with the advertiser selecting the annotation and its placement within the eBook. In addition, annotations themselves can be sold separately from the eBook, so that someone paying for the annotation can already have the eBook for that annotation. This divorces the cost of the eBook from the cost of the annotation, which can then be treated as two separate digital items. Likewise, if a user has added advertisements, there can be a credit, in terms of money or points, applied to the user's account, such that that credit can be applied to future purchases of eBooks and/or annotations.

### Exemplary Embodiment

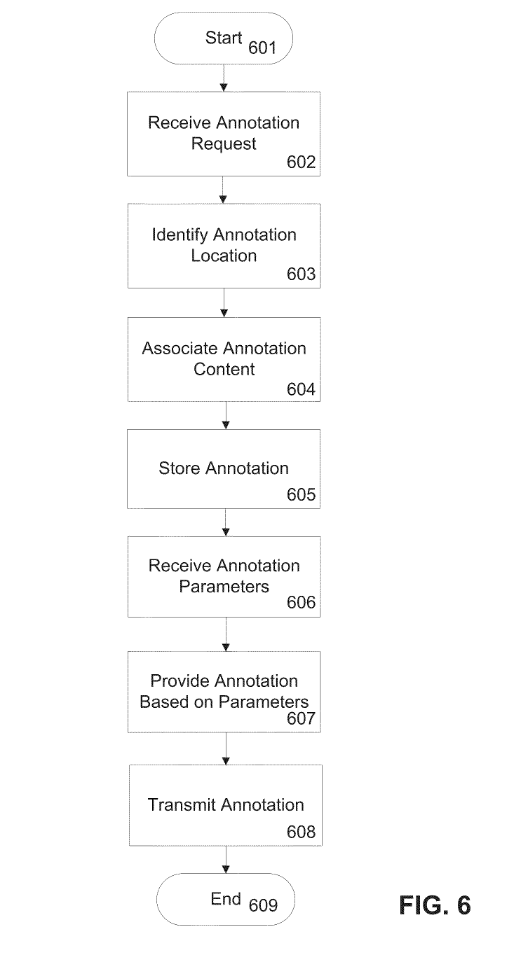

Turning now to FIG. 6, an exemplary method in accordance with an embodiment of the present invention is shown. In this method, the process starts at step 601 with a user interacting with the system. At step 602, the system receives an annotation request from the user. The annotation request is the initial interaction with a user who wishes to place an annotation in an eBook or other form of digital content (collectively referred to as “eBooks” for the purpose of the method descriptions).

At step 603, the system parses the annotation request and identifies the desired location identified by the user for the annotation. The annotation location may be any of the annotation location formats identified previously herein, including in line annotations and/or identified location annotations.

Once the annotation location has been identified, the system associates content identified by the user with the annotation location at step 604. The associated content may include, but is not limited to, multimedia content, text content, graphic content, video content, audio content, advertising content, or any combination thereof. One of ordinary skill in the art would appreciate that there are numerous types of content that may be associated with an annotation, and embodiments of the present invention are contemplated for use with any type of annotation content.

At step 605, the system stores the annotation in association with the eBook. The storage of the annotation may be local (e.g., storage device on the user's computing device), remote (e.g., storage on a remote computing device) or any combination thereof (e.g., local and remote storage in order to preserve the annotation across multiple devices and/or between multiple users).

At step 606, the system receives annotation parameters from the user. Annotation parameters revolve around the exposure of the annotation to others, such as those associated with one or more social network connections or publicly available associations. The annotation parameters could be provided at the same time as the annotation request, or later after the initial annotation has been stored.

At step 607, the system may receive a request from a second user searching for or identifying annotations with respect to an eBook. Assuming the second user's search parameters or identifiers match the annotation parameters of the user submitting the annotation, the system may provide the annotation to the second user (step 608). The provision may include the annotation itself as well as location information and other information related to the annotation (e.g., identity of submitting user). After provision of the annotation, the process terminates at step 609. One of ordinary skill in the art would appreciate that the steps of this method could be broken into multiple methods, such as those only associated with the incorporation of an annotation into an eBook or only those associated with the provision of annotations to secondary users.

As the annotations are to be searched and the user can decide which annotations to display on their digital content (eBook), the system will allow for the display of annotations where the annotations can be for the entire eBook, a certain chapter, or for the page(s) the user is currently viewing on their device. The annotations can be rated by other users, such that the display of results can be ordered to show annotations with the highest rating and most views on top, thereby making it easier for the user to decide which annotations to display on their digital content.

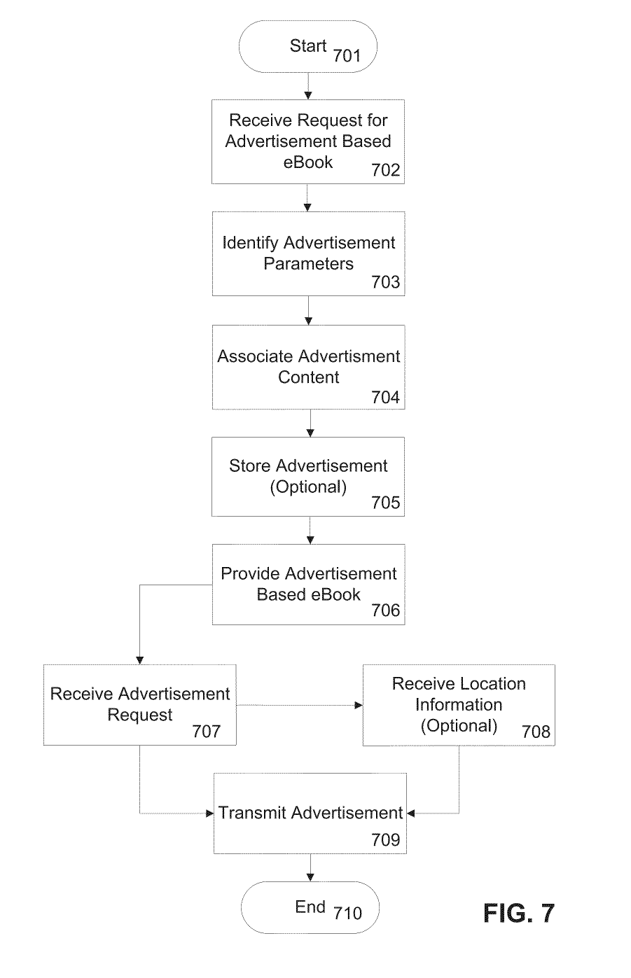

Turning now to FIG. 7, an exemplary method in accordance with an embodiment of the present invention is shown. In this method, the process starts at step 701 with a user interacting with the system. At step 702, the system receives a request from the user for an eBook incorporating advertisements.

At step 703, the system parses the request and identifies the parameters associated with the request. The parameters may include, but are not limited to, the identification by the user of the number, frequency and type (e.g., static, dynamic, location based) of advertisements to be incorporated into the eBook. Depending on the parameters, the system may also be configured to calculate a price for the eBook, based at least in part on the number and type of advertisements incorporated into the eBook.

At step 704, the system incorporates the advertising content into the eBook. The type, number and format of the advertising content may be based at least in part on the advertisement parameters. Other variables for selection and inclusion of the advertisements may include information associated with the user (e.g., age, gender, preferences, education level, profession, previous eBooks purchased). One of ordinary skill in the art would appreciate that there are numerous variables that could be utilized for the selection and inclusion of advertisements in an eBook and embodiments of the present invention are contemplated for use with any appropriate variable.

At step 705, the optional step of storing advertisements in an eBook is processed. This generally occurs where there are static advertisements to be included in an eBook, allowing for the advertisements to be displayed, even when the computing device of the user has limited or no access or ability to receive dynamic or location based advertisements.

At step 706, the eBook is provided to the user.

At step 707, the user interacts with the eBook and the system is engaged for an advertisement request (e.g., provision of a dynamic or location based advertisement). At optional step 708, the system received location information from the computing device of the user, allowing for the provision of location based advertisements. At step 709, advertisements are transmitted to the user's computing device and displayed within the eBook. The process concludes at step 710. One of ordinary skill in the art would appreciate that the steps of this method could be broken into multiple methods, such as those only associated with the incorporation of an advertisement into an eBook or only those associated with the provision of advertisements to readers of the eBook.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for providing interactive eBook content annotations and advertisements, the system comprising:
an annotation module, comprising computer-executable code stored in non-volatile memory,
an advertising module comprising computer-executable code stored in non-volatile memory,
a processor, and
a communications means,
wherein said advertising module, said annotation module, said processor, and said communications means are operably connected and are configured to:
receive an annotation request from a first user;
identify an annotation location based on said annotation request;
identify an annotation content based on said annotation request;
generate a identified location based annotation based at least in part on said annotation content and said annotation location; and
store said identified location based annotation in association with an eBook or other digital content format.

2. The system of claim 1, wherein said annotation content is selected from the group comprising video, audio, text, hyperlinks, multimedia content and advertisements.

3. The system of claim 1, wherein said identified location based annotation is made available to one or more secondary users.

4. The system of claim 3, wherein said one or more secondary users are linked to said first user via a social network connection.

5. The system of claim 3, wherein said one or more secondary users are linked to said first user via a public connection.

6. The system of claim 3, wherein said identified location based annotation is provided to one or more of said one or more secondary users as a result of a search conducted by said one or more secondary users.

7. The system of claim 6, wherein said search conducted by said one or more secondary users identified said identified location based annotation based at least in part on matching a subset of text in proximity to said annotation location and a second text identified by said one or more of said one or more secondary users present in a second eBook.

8. The system of claim 1, wherein said annotation is an advertisement and said advertising module, said annotation module, said processor, and said communications means are further configured to amend a price of said eBook or other digital content format, wherein said price of said eBook or other digital content format is lower or higher than a standard price for said eBook or other digital content format.

9. The system of claim 8, wherein said advertising module, said annotation module, said processor, and said communications means are further configured to provide said eBook or other digital content format to a second user at said price.

10. A computer implemented method for providing interactive eBook content annotations and advertisements, the method comprising the steps of:
receiving an annotation request from a first user;
identifying an annotation location based on said annotation request;
identifying an annotation content based on said annotation request;
generating a identified location based annotation based at least in part on said annotation content and said annotation location; and
storing said identified location based annotation in association with an eBook or other digital content format.

11. The method of claim 10, wherein said annotation content is selected from the group comprising video, audio, text, hyperlinks, multimedia content and advertisements.

12. The method of claim 10, wherein said identified location based annotation is made available to one or more secondary users.

13. The method of claim 12, wherein said one or more secondary users are linked to said first user via a social network connection.

14. The method of claim 12, wherein said one or more secondary users are linked to said first user via a public connection.

15. The method of claim 12, wherein said identified location based annotation is provided to one or more of said one or more secondary users as a result of a search conducted by said one or more secondary users.

16. The method of claim 15, wherein said search conducted by said one or more secondary users identified said identified location based annotation based at least in part on matching a subset of text in proximity to said annotation location and a second text identified by said one or more of said one or more secondary users present in a second eBook.

17. The method of claim 10, wherein said advertising module, said annotation module, said processor, and said communications means are further configured to amend a price of said eBook or other digital content format, wherein said price of said eBook or other digital content format is lower or higher than a standard price for said eBook or other digital content format.

18. The method of claim 17, wherein said advertising module, said annotation module, said processor, and said communications means are further configured to provide said eBook or other digital content format to a second user at said price.
